(19) United States
(12) Patent Application Publication
(10) Pub. No.: US 2020/0033495 A1
(43) Pub. Date: Jan. 30, 2020

(54) METHOD AND APPARATUS FOR OBTAINING STATISTICAL MEASURES OF GEOLOGICAL PROPERTIES VALUES RELATED TO LATERAL WELLS USING SEISMIC-DERIVED MAPS

(71) Applicant: CGG SERVICES SAS, Massy Cedex (FR)

(72) Inventor: Julio TAVARES, Houston, TX (US)

(21) Appl. No.: 16/263,876

(22) Filed: Jan. 31, 2019

Related U.S. Application Data
(60) Provisional application No. 62/711,714, filed on Jul. 30, 2018.

(51) Int. Cl. G01V 1/50; G06F 17/18; E21B 47/18

(52) U.S. Cl. CPC G01V 1/50; G01V 2210/1234; E21B 47/18; G06F 17/18

(57) ABSTRACT

A method for statistical analysis of geological property values for lateral wells based on seismic-derived attribute values is provided. A grid of points is created for the lateral well. The grid points are then fitted to a subset of seismic bins. The attribute values along the lateral well are estimated from map values associated with the fitted points. Statistical measures of the estimated attribute values are provided for assessing hydrocarbon productivity.

### BACKGROUND

### Technical Field

Embodiments of the subject matter disclosed herein generally relate to methods and apparatuses used for estimating various geophysical properties in lateral well areas, and, in particular, to obtaining statistical measures of geophysical properties values related to lateral wells based on seismic-derived maps of values, the statistical measures being then used for assessing hydrocarbon productivity of the lateral well.

### Discussion of the Background

Lateral (also known as “horizontal”) wells have proven particularly useful in the hydraulic fracking process employed in extracting gas and oil from shale reservoirs. These reservoirs tend to be inaccessible to traditional vertical drilling due to the impermeability of the shale formations. In order to extract gas and oil, a compound of water, chemicals and guar gum, also known as mud, is pumped into lateral wells. The force of these injections fractures the rock, creating openings through which petroleum flows.

Geological and engineering parameters are used in well performance analysis to assess hydrocarbon productivity. Existing approaches to well performance analysis tend to rely on drilling and completion parameters and on geological information from well logs and rock samples (such as core plugs and cuttings).

FIG. 1 illustrates a well including a borehole 101 between well head 110 and landing point 120 and a lateral well 102 between landing point 120 and well bottom 130. The lateral well is dug using a directional drilling technique at a drilling angle of at least 80° to vertical direction (i.e., a virtual line between well head 110 and a point vertically underneath the well head, the point being labeled 111 in FIG. 1). Lateral wells enable retrieval of oil and gas when the shape of the reservoir is abnormal or difficult to access (e.g., in shale). A lateral length (LL) between landing point 120 and well bottom 130 may be larger than the borehole's length between well head 110 and landing point 120.

Most well logging tools cannot be used in lateral wells due to operational limitations. Additionally, retrieving a representative rock sample set for analysis is prohibitively expensive on long lateral wells, when, in a production field, hundreds of wells may have to be analyzed. For instance, along a 9,000 ft lateral well, it would be necessary to collect about 300 samples (with spacing of 30 ft) to acquire enough samples to characterize the well's geophysical attributes. Furthermore, when simultaneously analyzing multiple wells in a production field to compare and understand different productivities, the use of well logs and numerous rock samples becomes challenging (i.e., costly and time-consuming).

In a recently proposed approach (described in Lu, L. et al.'s 2017 article entitled “Advanced Machine Learning for Unconventional Plays” published in 79^{th} EAGE Extended Abstract WS01 P01), a machine learning sweetspotting workflow is used to identify higher production areas in unconventional plays. In another recent approach (described in Anderson, R. N. et al.'s 2016 article entitled “Petroleum analytics learning machine to forecast production in the wet gas Marcellus shale” published in proceedings of the 2016 Unconventional Resources Technology Conference, URTC #24266123), a generalized multi-dimensional analytics system inputs all available data into an ensemble of machine learning to forecast production. U.S. Patent Application Publication No. 2017/0364795 describes a machine learning approach-based “brutally empirical” analysis system. In yet another recent approach (described in Wicker, J. et al.'s 2017 article entitled “Optimization of horizontal wells utilizing multi-variate analytics of seismic inversion in the Wolfcamp formation of the Midland basin” published in proceedings of the 2017 AAPB Annual Convention and Exhibition, Search and Discovery Article #42081), multi-variate analytics are used to predict cumulative oil production volumes of horizontals at a set point in time. This approach uses 3D seismic volumes yielding accurate and reliable results if data is in-depth. All the references cited in this paragraph are incorporated by reference in their entirety.

There is a continuing need to develop methods and systems that efficiently predict hydrocarbon productivity in wells.

### SUMMARY

Methods and apparatuses according to various embodiments provide obtain statistical measures of geophysical attribute values related to lateral wells using seismic-derived attribute value maps.

According to an embodiment there is a method for obtaining statistical measures of attribute values related to a lateral well. The method includes receiving coordinates of a lateral well and a map of seismic-derived attribute values for an arrangement of seismic bins covering the lateral well, creating a grid of points related to the lateral well, and fitting the points of the grid to a subset of the seismic bins. The method then includes providing statistical measures of the seismic-derived attribute values corresponding to the fitted points for assessing hydrocarbon productivity.

According to another embodiment there is an apparatus for obtaining statistical measures of attribute values related to a lateral well, the apparatus including an input/output interface and a processor. The input/output interface is configured to receive coordinates of a lateral well and a map of seismic-derived attribute values for an arrangement of seismic bins covering the lateral well. The processor is connected to the input/output interface and configured: to create a grid of points related to the lateral well, to fit the points of the grid to a subset of the seismic bins in the arrangement; and to provide statistical measures of the seismic-derived attribute values corresponding to the fitted points for assessing hydrocarbon productivity.

According to yet another embodiment there is a non-transitory computer readable recording medium storing executable codes, which when executed by a computer makes the computer perform a method for obtaining statistical measures of attribute values related to a lateral well. The method includes receiving coordinates of a lateral well and a map of seismic-derived attribute values for an arrangement of seismic bins covering the lateral well, creating a grid of points related to the lateral well, and fitting the points of the grid to a subset of the seismic bins. The method then includes providing statistical measures of the seismic-derived attribute values corresponding to the fitted points for assessing hydrocarbon productivity.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a well including a borehole and a lateral well;

FIG. 2 is a flowchart of a method according to an embodiment;

FIG. 3 is a workflow according to an embodiment;

FIG. 4 is a graph illustrating representative points of a lateral well;

FIG. 5 is a map of seismic-derived porosity values;

FIG. 6 illustrates reference points according to an embodiment;

FIG. 7 illustrates generating grid points according to an embodiment;

FIG. 8 illustrates an overlap of the grid and seismic map cells;

FIG. 9 illustrates fitted grid points according to an embodiment;

FIG. 10 are graphs showing the fitting effect;

FIG. 11 is a histogram of porosity values with statistic measures; and

FIG. 12 is a schematic diagram of an apparatus useable for performing various methods according to an embodiment.

### DETAILED DESCRIPTION

The following description of the exemplary embodiments refers to the accompanying drawings. The same reference numbers in different drawings identify the same or similar elements. The following detailed description does not limit the invention. Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places is not necessarily referring to the same embodiment. Further, the particular features, structures or characteristics may be combined in any suitable manner in one or more embodiments.

FIG. 2 is a flowchart of a method 200 for obtaining statistical measures of geological, elastic or mineralogic property values (the term “geophysical” used in this document is meant to encompass all the property types) related to a lateral well according to an embodiment. The term “attribute” is used hereinafter to refer to any geophysical property obtained from an initial seismic data processing.

At 210, method 200 includes receiving coordinates of a lateral well and a map of seismic-derived attribute values for an arrangement of seismic bins on a surface including the lateral well. At 220, method 200 includes creating a grid of points related to the lateral well. At 230, the points of the grid are fit to a subset of the seismic bins to enable providing statistical measures of attribute values corresponding to the fitted points for assessing hydrocarbon productivity at 240.

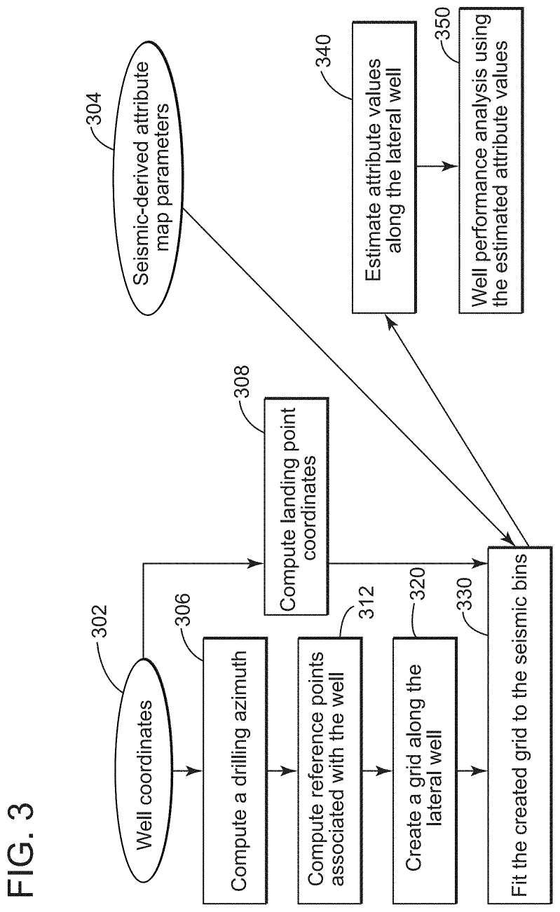

To better explain the steps in method 200, FIG. 3 illustrates a workflow according to an embodiment. The workflow in FIG. 3 is just one of plural alternatives for implementing the steps of method 200.

Thus, step 210 refers to the method's inputs: (1) coordinates of a lateral well labeled 302 in FIG. 3, and (2) a map of seismic-derived attribute values for an arrangement of seismic bins labeled 304 in FIG. 3.

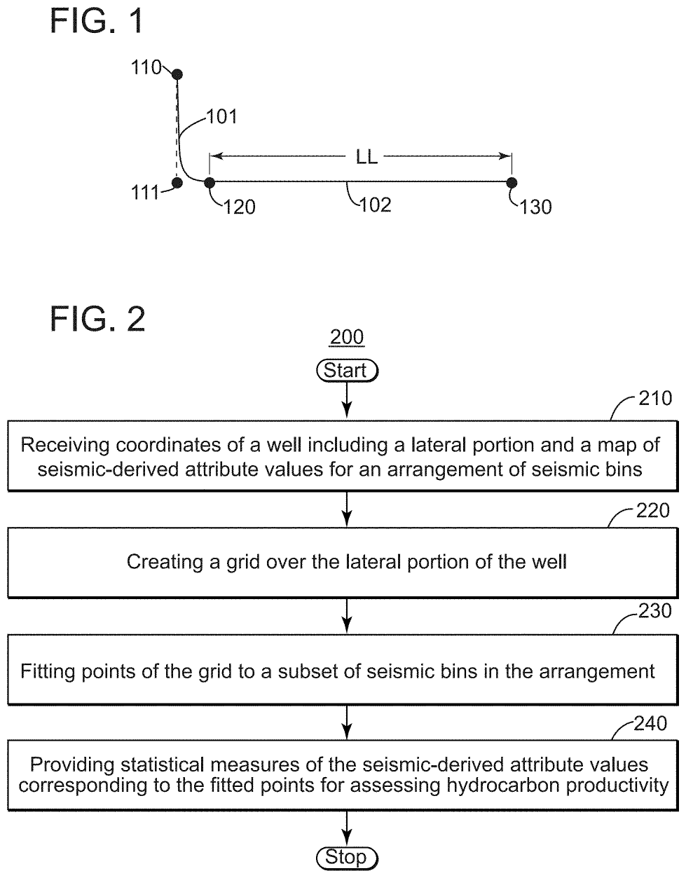

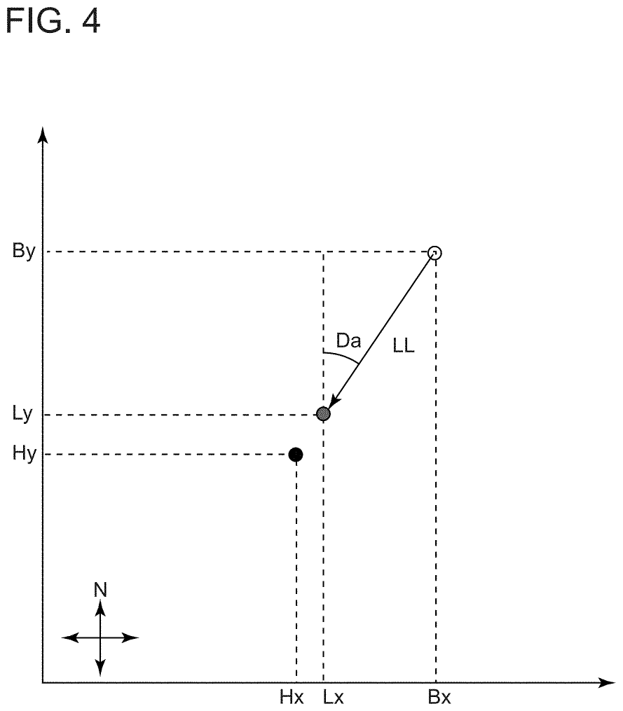

Relative to (1), consider the graph in FIG. 4, where the well head (e.g., 110 in FIG. 1) has coordinates (Hx, Hy) and the well bottom (e.g., 130 in FIG. 1) has coordinates (Bx, By). Note that North is the y-axis direction as suggested by the indicator in the left bottom corner of FIG. 4. Based on the coordinates, the drilling azimuth Da may be calculated at 306 using the well head's and bottom's coordinates:

$$Da = arctan \frac{Dx}{Dy} = arctan \frac{Bx - Hx}{By - Hy} . \qquad ( 1 )$$

The landing point (e.g., 120 in FIG. 1) is at lateral length (LL) distance from the well bottom of coordinates (Bx, By). Coordinates of the landing point (e.g., 120 in FIG. 1) may optionally be calculated at 308 as:

Lx=Bx−LL sin Da

Ly=By−LL cos Da (2)

The expression “coordinates of a well” is not limited to the well head's and well bottom's coordinates, instead covering any combination of pieces of information sufficient to determine the location of the lateral well. For example, in one embodiment, the coordinates of the well include well head's coordinates, lateral well's depth (which may be expressed in as seismic travel time), a lateral length and a drilling azimuth. An operational-limited radius for drilling to change direction (i.e., from a vertical direction of the borehole to a substantially horizontal direction of the lateral well) may also be known.

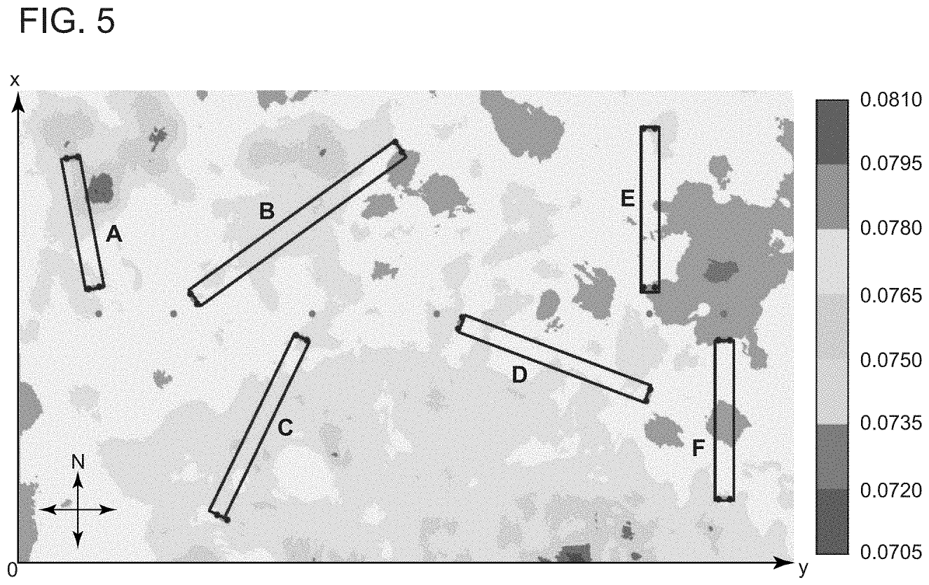

Relative to (2), that is, the seismic-derived attribute map FIG. 5 is a map of porosity with different nuances of gray corresponding to different porosity ranges as suggested by the legend on the right. The rectangles A-F are projections in horizontal plane of lateral wells. Each lateral well may be defined by well head's coordinates in horizontal plane, well bottom's coordinates in horizontal plane and lateral length. For each point (cell) of the map there is an attribute value associated.

Using key interpreted horizons within the seismic volume (as described for example, in Chapters 3 and 4 of “Interpretation of Three-Dimensional Seismic Data” by Alistair Brown, published by American Association of Petroleum Geologists and the Society of Exploration Geophysicists, SEG, in 2011, and in Chapter 11 of “Fundamentals of Geophysical Interpretation” by Laurence R. Lines and Rachel T. Newrick, published by SEG in 2004) related to top and/or base of geological formations and/or reservoir intervals, geological attribute maps representative for the target interval may be extracted over the entire seismic survey area. For instance, when extracting interval (or layer) properties, such as elastic, petrophysical, geomechanical and geochemical, mean values can be extracted between the top and base of a reservoir or geological formation of interest (target interval). On the other hand, when dealing with interface seismic properties, such as amplitude, frequency and phase attributes, a horizon slice at the top and/or base of the interval of interest (target interval) can be extracted to generate additional seismic attribute maps.

Suitable attributes include one or more elastic properties (e.g., P-impedance, S-impedance, Poisson's Ratio Vp/Vs where Vp is speed of primary (compressional) waves and Vs is speed of secondary (shear) waves, rock brittleness λ (which may be calculated as λ=ρ(Vₚ²−Vₛ²), density, shear modulus, μ), anisotropy and pore pressure properties (e.g., crack density, azimuth of fractures, normal weakness, tangential weakness, anisotropic magnitude, minimum horizontal stress, maximum horizontal stress, overburden pressure, pore pressure), additional rock properties (e.g., total porosity, kerogen type, maturity) and/or facies/geology properties (e.g., pay, shale, calcerous mudstone, seliceious mudstone, shaley mudstone, and the like). Each cell of the map is associated with an attribute value (e.g., a triad made of a cell center's coordinates in a horizontal plane and the attribute value is obtained from seismic data and may be stored in a memory). Although FIG. 5 illustrates a continuous surface, in more general sense the map is a collection of coordinates and attribute values for an arrangement of cells (which may be square or hexagonal, etc.) in a plane or at a layer interface (e.g., a horizon). A cell size may be defined as distance between centers of adjacent cells.

This map-based approach is useful when the seismic data is in time, not depth. Converting from time to depth (as described, for example, in Chapter 11 of the previously mentioned “Interpretation of Three-Dimensional Seismic Data” by Alistair Brown) can be complex and tends to take a few months. The present maps approach is useful for efficiency when good quality seismic data (with good horizons) is available. Obtaining these maps is described, for example, in Chapter 8A of “Interpretation of Three-Dimensional Seismic Data” by Alistair Brown, and in Chapter 3 of “Handbook of Poststack Seismic Attributes” by Arthur E. Barnes published by SEG in 2016.

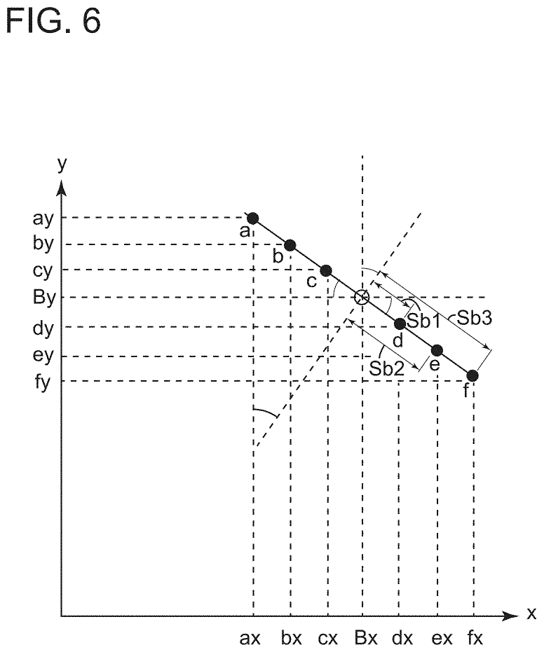

In order to build the grid of points related to the lateral well at 320, the workflow illustrated in FIG. 3 first computes reference points associated with the lateral well at 312. In the embodiment illustrated in FIG. 6, these reference points (a, b, c, d, e and f) are located along a line passing through the well bottom of coordinates (Bx, By) and perpendicular to the lateral well. The interval between the reference points may be chosen to be equal to the seismic bin size Sb. Thus, using notation Sb2=2Sb and Sb3=3Sb, the coordinates of reference points a-f can be calculated using the following set of formulas:

ax=Bx−Sb3 cos Da

ay=By −Sb3 sin Da

bx=Bx−Sb2 cos Da

by=By −Sb2 sin Da

cx=Bx−Sb cos Da

cy=By −Sb sin Da

dx=Bx+Sb cos Da

dy=By+Sb sin Da

ex=Bx+Sb2 cos Da

ey=By+Sb2 sin Da

fx=Bx+Sb3 cos Da

fy=By+Sb3 sin Da (3).

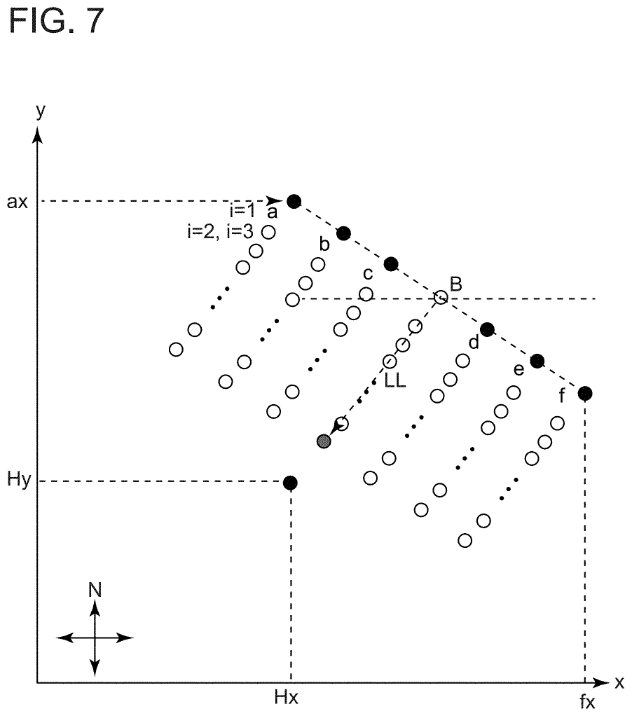

Further to create the grid at 320, from each reference point are generated a series of grid points located along lines parallel to the lateral well as illustrated in FIG. 7. For each i from 1 to largest integer less than (LL/Sb), the grid includes points having the coordinates (axi,ayi), (bxi,byi), (cxi,cyi), (Bxi,Byi), (dxi,dyi), (exi,eyi), (fxi,fyi) calculated with the following set of formulas:

axi=ax−i×Sb sin Da

ayi=ay−i×Sb cos Da

bxi=bx−i×Sb sin Da

byi=by −i×Sb cos Da

cxi=cx−i×Sb sin Da

cyi=cy−i×Sb cos Da

Bxi=Bx−i×Sb sin Da

Byi=By −i×Sb cos Da

dxi=dx−i×Sb sin Da

dyi=dy−i×Sb cos Da

exi=ex−i×Sb sin Da

eyi=ey−i×Sb cos Da

fxi=fx−i×Sb sin Da

fyi=fy−i×Sb cos Da (4).

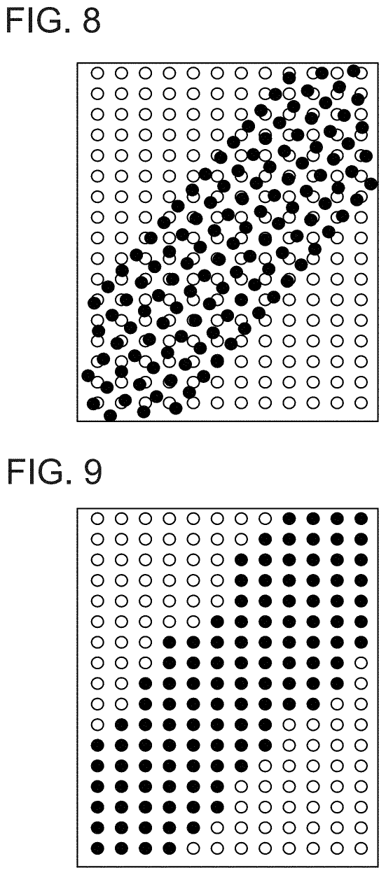

The grid of points covering the lateral well does not correspond to the seismic bins, as illustrated in FIG. 8. Therefore, at 330, each point of the grid is fitted to a closest map cell as illustrated in FIG. 9. The fitted point j of coordinates (Fx(j),Fy(j)) is inside a map cell (e.g., matches a center thereof), and its coordinates meet the following constraints relative to the grid point's coordinates prior to fitting (Rx(j),Ry(j)):

Rx(j)−Sb≤Fx(j)≤Rx(j)+Sb

Ry(j)−Sb≤Fy(j)≤Ry(j)+Sb (5).

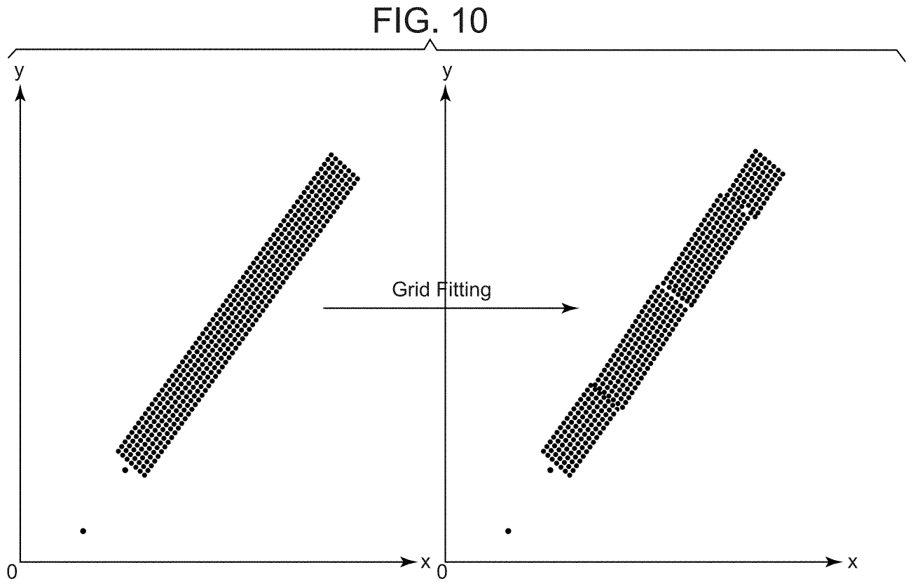

FIG. 10 illustrates the grid of points corresponding to well B in FIG. 5 prior to fitting in the left-hand graph and fitted points in the right-hand graph. The fitted grid points are then associated with the map values in respective cells at 340.

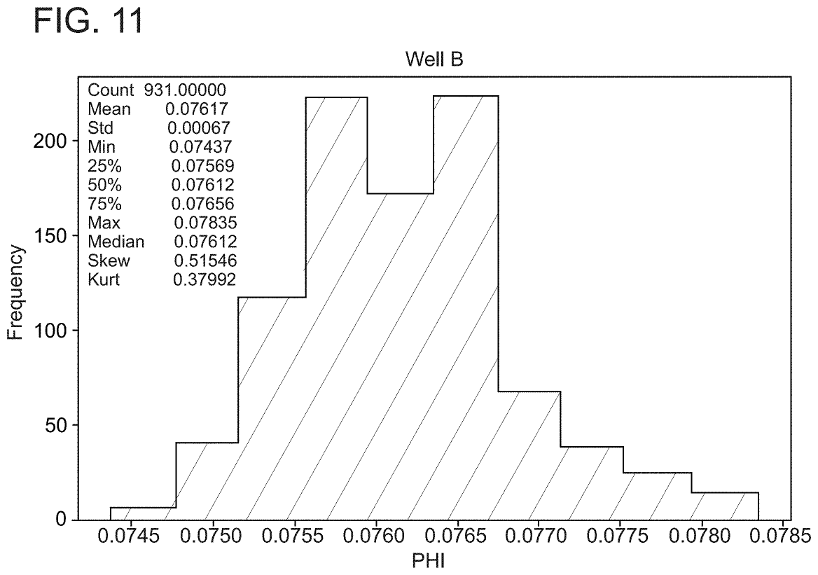

FIG. 11 is a histogram of the values for porosity obtained using the above method (for lateral well B in FIG. 5). Statistical analysis of these values is then performed and may then be used to evaluate well performance at 350.

If engineering data such as drilling and completion parameters are available, it may be used along with the geophysical parameters (seismic-derived attributes) for an integrated well performance analysis, taking into account both geology and engineering scenarios.

Suitable engineering completion parameters (see, e.g., “Petroleum Analytics Learning Machine to Forecast Production in the Wet Gas Marcellus Shale,” by Anderson et al, URTeC #2426612, San Antonio, pp. 132-147, pp. 145-146,) include one or more of number of stages, average stage length, perforated lateral length, number of clusters, frac fluid volume, average proppant concentration, pump rate, frac sand volume, quality, size and shape. For example, suitable engineering completion parameters includes one or more of linear density (e.g., in pounds/ft), average stage length (ft per stage), number of stages, clusters, prop/cluster, perf lateral length (ft), perfs (ft), lat# length (miles), fac fluid volume (bbls), sweeps pumped, ave# prop conc#, frac sand volume (lbs), bbl/ft, nanos used, oil plus used, pump rate BPM, % oil plus 30/50, 30/50 mesh %, 30/50 quality, 40/70 sand %, 40/70 sand %, 40/70 quality, 100 mesh %, 100 mesh quality.

An integrated well performance analysis used for assessing hydrocarbon productivity may include a machine learning technique to determine relationships among the variables. For example, the techniques may include one or more of determining the correlation of geosciences properties with geoscience properties and the correlation of completion properties with completion properties and developing an analytical model of the geoscience properties and the completion properties. The technique may include evaluating multilinear relationships among the properties. The machines learning technique may involve a supervised learning method. Suitable supervised learning methods are random forest and gradient boosting. The machine learning technical may include a data preparation step of principal component analysis. The integrated well performance analysis may include predicting one or more of a sweetspot map and normalized production.

The above-described approach allows extraction of a wide variety of geologically consistent statistical measures for lateral wells from seismic-derived attributes, instead of acquiring measurements for hundreds of wells in a production field. This approach is highly efficient in terms of computer resources and provides good insights about the variability of geological properties along lateral wells using seismic-derived attribute maps as input data. When hundreds of wells and dozens of seismic-derived attribute maps are available, a dataset for further analysis is efficiently created using this approach, with several statistical estimates for each well based on seismic-derived attribute maps. The approach improves computer efficiency in analyzing seismic-derived attributes to predict well performance, such as hydrocarbon productivity.

Prior to the above-described approach, tying measurements in a well to seismic data was performed manually by a geophysics evaluator selecting one seismic attribute value at a single well location. The use of a single point is valid if assumed geological homogeneity is correct. However, while the assumption of homogeneity is typically suitable for vertical wells, it tends to be a poor assumption for lateral wells. For example, whereas a single value of porosity may be suitable for a vertical well, porosity tends to attain multiple values along a lateral well. The present approach allows efficient association of a statistical distribution of attribute values to a lateral well, rather than a single attribute value.

The various embodiments also take advantage of plural seismic-derived geological properties, such as elastic, petrophysical, geomechanical and geochemical, besides amplitude, frequency and phase attributes, to build a geologically consistent dataset (statistical measurements) for each well inside the seismic survey by extracting statistical values of these seismic-derived geological attributes along the lateral well trajectories. Using this approach, one can build a consistent and rich dataset for individual well performance analysis as well as multiple wells analysis using data analytics workflows.

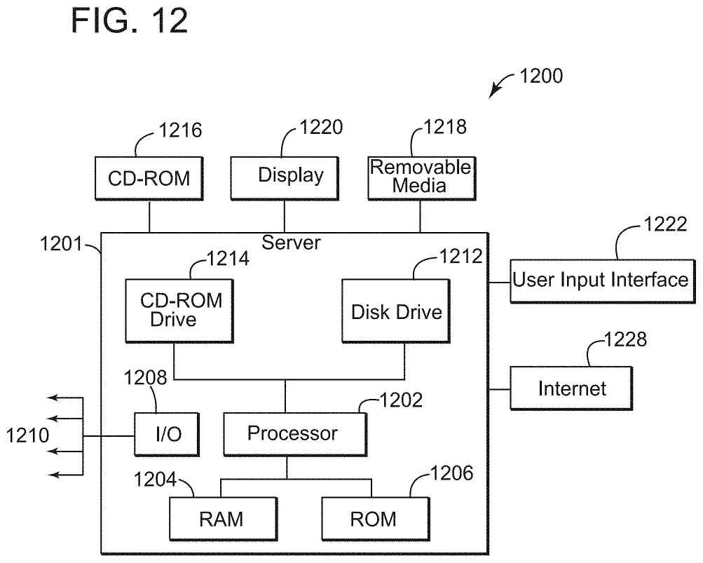

The above-discussed methods may be implemented in a computing device 1200 as illustrated in FIG. 12. Hardware, firmware, software or a combination thereof may be used to perform the various steps and operations described herein.

Exemplary computing device 1200 suitable for performing the activities described in the exemplary embodiments may include a server 1201. Server 1201 may include a central processor (CPU) 1202 coupled to a random access memory (RAM) 1204 and to a read-only memory (ROM) 1206. ROM 1206 may also be other types of storage media to store programs, such as programmable ROM (PROM), erasable PROM (EPROM), etc. Processor 1202 may communicate with other internal and external components through input/output (I/O) circuitry 1208 and bussing 1210 to provide control signals and the like. Processor 1202 carries out a variety of functions as are known in the art, as dictated by software and/or firmware instructions.

Server 1201 may also include one or more data storage devices, including hard drives 1212, CD-ROM drives 1214 and other hardware capable of reading and/or storing information, such as DVD, etc. In one embodiment, software for carrying out the above-discussed steps may be stored and distributed on a CD-ROM or DVD 1216, a USB storage device 1218 or other form of media capable of portably storing information. These storage media may be inserted into, and read by, devices such as CD-ROM drive 1214, disk drive 1212, etc. Server 1201 may be coupled to a display 1220, which may be any type of known display or presentation screen, such as LCD, plasma display, cathode ray tube (CRT), etc. A user input interface 1222 is provided, including one or more user interface mechanisms such as a mouse, keyboard, microphone, touchpad, touch screen, voice-recognition system, etc.

Server 1201 may be coupled to other devices, such as sources, detectors, etc. The server may be part of a larger network configuration as in a global area network (GAN) such as the Internet 1228, which allows ultimate connection to various computing devices.

The disclosed embodiments provide methods and apparatuses for obtaining statistical measures of attribute values related to a lateral well for assessing hydrocarbon productivity. It should be understood that the current description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a general-purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for obtaining statistical measures of attribute values related to a lateral well, the method comprising:
receiving coordinates of a lateral well and a map of seismic-derived attribute values for an arrangement of seismic bins covering the lateral well;
creating a grid of points related to the lateral well;
fitting the points of the grid to a subset of the seismic bins; and
providing statistical measures of the seismic-derived attribute values corresponding to the fitted points for assessing hydrocarbon productivity.

2. The method of claim 1, wherein the creating of the grid includes computing coordinates of reference grid points aligned perpendicular to the lateral well.

3. The method of claim 2, wherein the creating of the grid further includes computing grid points along lines substantially parallel to the lateral well and passing through the reference grid points, wherein a distance between adjacent reference grid points, one of the reference grid points and one of the grid points, or grid points along one of the lines is substantially equal to the cell size of the map.

4. The method of claim 1, wherein the grid is symmetric relative to the lateral well.

5. The method of claim 1, wherein the fitting of the points to the subset of seismic bins includes, for each point of the grid, finding a corresponding closest map cell.

6. The method of claim 1, wherein the statistical measures of attribute values are obtained by:
populating a histogram with map values obtained by associating a map value in a respective closest map cell to each fitted point; and
extracting one or more of the statistical measures based on the histogram.

7. The method of claim 1, wherein the one or more statistical measures includes mean, standard deviation, minimum value, percentiles of value distribution, maximum value, median, skewness, kurtosis, and/or combinations thereof.

8. The method of claim 1, wherein the attribute is an elastic property, anisotropy or pore-related property, or a facies/geology-related property.

9. The method of claim 1, further comprising:
receiving an additional map of other seismic-derived attribute values for the arrangement of seismic bins; and
providing other statistical measures of the other seismic-derived attribute values corresponding to the fitted points for the assessing hydrocarbon productivity.

10. The method of claim 1, further comprising:
receiving coordinates of another lateral well; and
creating another grid of other points related to the other lateral well;
fitting the other points to another subset of the seismic bins in the arrangement; and
providing other statistical measures of the seismic-derived attribute values corresponding to the other fitted points for the assessing hydrocarbon productivity.

11. An apparatus for obtaining statistical measures of attribute values related to a lateral well, the apparatus comprising:
an input/output interface configured to receive coordinates of a lateral well and a map of seismic-derived attribute values for an arrangement of seismic bins covering the lateral well; and
a processor connected to the input/output interface and configured:
to create a grid of points related to the lateral well;
to fit the points of the grid to a subset of the seismic bins in the arrangement; and
to provide statistical measures of the seismic-derived attribute values corresponding to the fitted points for assessing hydrocarbon productivity.

12. The apparatus of claim 11, wherein when creating the grid the processor computes coordinates of reference grid points aligned perpendicular to the lateral well, and then computes grid points along lines substantially parallel to the lateral well and passing through the reference grid points,
wherein a distance between adjacent reference grid points, one of the reference grid points and one of the grid points, or grid points along the lines is substantially equal to the cell size of the map.

13. The apparatus of claim 11, wherein the grid is symmetric relative to the lateral well.

14. The apparatus of claim 11, wherein, when fitting the points to the subset of seismic bins includes, for each point of the grid, the processor finds a corresponding closest map cell.

15. The apparatus of claim 11, wherein the processor obtains the statistical measures of the attribute values by:
populating a histogram with map values obtained by associating a map value in a respective closest map cell to each fitted point; and
extracting one or more of the statistical measures based on the histogram.

16. The apparatus of claim 11, wherein the interface receives an additional map of other seismic-derived attribute values for the arrangement of seismic bins; and the processor provides other statistical measures of the other seismic-derived attribute values corresponding to the fitted points for assessing hydrocarbon productivity.

17. The apparatus of claim 11, wherein the interface receives coordinates of another lateral well, and the processor creates another grid of other points related to the other lateral well, fits the other points to another subset of the seismic bins in the arrangement, and provides other statistical measures of the seismic-derived attribute values corresponding to the other fitted points for the assessing hydrocarbon productivity.

18. A non-transitory computer readable recording medium storing executable codes, which when executed by a computer makes the computer perform a method for obtaining statistical measures of attribute values related to a lateral well, the method comprising:
receiving coordinates of a lateral well and a map of seismic-derived attribute values for an arrangement of seismic bins covering the lateral well;
creating a grid of points related to the lateral well;
fitting the points of the grid to a subset of the seismic bins; and
providing statistical measures of the seismic-derived attribute values corresponding to the fitted points for assessing hydrocarbon productivity.

19. The non-transitory computer readable recording medium of claim 18, wherein the method further comprises:
receiving an additional map of other seismic-derived attribute values for the arrangement of seismic bins; and
providing other statistical measures of the other seismic-derived attribute values corresponding to the fitted points for the assessing hydrocarbon productivity.

20. The non-transitory computer readable recording medium of claim 18, wherein the method further comprises:
receiving coordinates of another lateral well; and
creating another grid of other points related to the other lateral well;
fitting the other points to another subset of the seismic bins in the arrangement; and
providing other statistical measures of the seismic-derived attribute values corresponding to the other fitted points for the assessing hydrocarbon productivity.
